(19) United States
(12) Patent Application Publication
(10) Pub. No.: US 2007/0219931 A1
(43) Pub. Date: Sep. 20, 2007

(54) Systems and methods for prioritizing and tracking cost reduction projects

(75) Inventors: Bassel H. Daoud, Parsippany, NJ (US); Christopher K. Wiese, Long Valley, NJ (US)

Correspondence Address: PRIEST & GOLDSTEIN, PLLC, 5015 SOUTHPARK DR, SUITE 230, DURHAM, NC, 27713, US

(73) Assignee: Lucent Technologies Inc., Murray Hill, NJ (US)

(21) Appl. No.: 11/376,800

(22) Filed: Mar. 16, 2006

(51) Int. Cl. G06F 17/00

(52) U.S. Cl. 705/400

(57) ABSTRACT

Determining how to prioritize cost reduction projects for replacing subcomponents composing an assembled product with new subcomponents is described. To this end, forecast sales data for subcomponents composing the assembled product is received. Utilizing the forecast sales data, a cost savings schedule for subcomponents of costs saved by introducing the new subcomponents is then determined. The total cost savings for each cost reduction project is then calculated. The cost reduction projects are then ordered according to their respective total cost savings to determine which cost reduction projects should be pursued.

### FIELD OF THE INVENTION

The present invention relates generally to improvements in the field of project management, and, in particular, to systems and methods for prioritizing and tracking cost reduction projects relating to subcomponents composing one or more assembled products.

### BACKGROUND OF THE INVENTION

Typically, the price at which an assembled product can be sold drops rather quickly over the life time of the product. An assembled product such as a telecommunication base station may comprise many subcomponents including filters, amplifiers, radios, and the like. Furthermore, the telecommunication base station may be sold in various configurations to meet customer scaling requirements. Each configuration may include a different quantitative mix of subcomponents. To be competitive in today's global economy and maintain a consistent profit, a business enterprise, which builds and sells the assembled product, needs to manage the costs of these subcomponents.

Many times these subcomponents can be replaced by cheaper subcomponents due to technology advances, manufacturing efficiency, and the like. Integrating new subcomponents into an assembled product can prove costly depending on the new subcomponent's complexity, physical dimension, connectivity to other subcomponents, and the like. For example, a new subcomponent may require additional software for it to operate in the assembled product, a new wiring plan to electrically connect the new subcomponent to the assembly, or a new packaging plan for the assembled product.

Since operating budgets of the business enterprise are limited, how does the business enterprise decide which subcomponents should be replaced? Out of the subcomponents chosen to be replaced, what goals should be used to determine a reasonable price reduction target? Without any goals, how can allocating development resources between projects defined by each new subcomponent be justified? When would be the best time to introduce an assembled product with one or more new subcomponents to minimize stranded inventory of old subcomponents and maximize savings? How does a business enterprise measure the effectiveness of introducing the assembled product with one or more new subcomponents? Conventionally, management teams of the business enterprise introduce an assembled product on an adhoc basis without being able to answer these and other related questions, resulting in wasting time on replacing subcomponents which do not affect the bottom line, increased development costs, and shrinking profits, if any at all, remain after introducing the new subcomponents.

### SUMMARY OF THE INVENTION

Among its several aspects, the present invention recognizes the need for prioritizing and tracking cost reduction projects for subcomponents composing one or more assembled products. Another aspect of the present invention provides systems, computer implemented methods, and computer readable media for determining how to prioritize cost reduction projects for replacing subcomponents composing an assembled product with new subcomponents. To this end, forecast sales data for subcomponents composing the assembled product is received. Utilizing the forecast sales data, a cost savings schedule for subcomponents of costs saved by introducing the new subcomponents is then determined. The total cost savings for each cost reduction project is then calculated. The cost reduction projects are then ordered according to their respective total cost savings to determine which cost reduction projects should be pursued.

A more complete understanding of the present invention, as well as further features and advantages of the invention, will be apparent from the detailed description, the accompanying drawings, and the claims.

### BRIEF DESCRIPTION OF THE DRAWINGS

FIG. 1 shows an illustrative system employing a cost reduction project management system in accordance with the present invention.

FIG. 2 shows exemplary software components of and interfacing to the cost reduction project management software 130 of FIG. 1 in accordance with the present invention.

FIGS. 3A and 3B (collectively FIG. 3) show a flow chart of an overall method for managing cost reduction projects in accordance with the present invention.

FIGS. 4A and 4B (collectively FIG. 4) show a flow chart of a method for determining a best of the best assembled product according to subcomponent costs and market based target costs in accordance with the present invention.

FIG. 5 shows a flow chart of a method for determining forecast schedule data for subcomponents common across one or more assembled products in accordance with the present invention.

FIG. 6 shows a flow chart of a method for determining the set of cost reduction projects to pursue in accordance with the present invention.

FIG. 7 shows a flow chart of a method for extracting additional overall cost savings by advancing the general availability (GA) date of high savings cost reduction projects in accordance with the present invention.

FIG. 8 shows an exemplary spreadsheet utilized in implementing a first portion of the prioritizing and tracking component of FIG. 2 in accordance with the present invention.

FIG. 9 shows an exemplary cost roadmap spreadsheet utilized in implementing a second portion of the prioritizing and tracking component of FIG. 2 in accordance with the present invention.

FIG. 10 shows an exemplary savings per subcomponent roadmap spreadsheet utilized in implementing a third portion of the prioritizing and tracking component of FIG. 2 in accordance with the present invention.

FIG. 11 shows an exemplary forecast roadmap spreadsheet to display forecast data on a subcomponent basis in accordance with the present invention.

FIG. 12 shows an exemplary monthly savings spreadsheet in accordance with the present invention.

FIG. 13 shows an exemplary year-to-date savings spreadsheet in accordance with the present invention.

### DETAILED DESCRIPTION

The present invention will now be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

As will be appreciated by one of skill in the art, the present invention may be embodied as methods, systems, or computer readable media. Furthermore, the present invention may take the form of a computer program on a computer-usable storage medium having computer-usable program code embodied in the medium. Any suitable computer readable medium may be utilized including hard disks, CD-ROMs, optical storage devices, flash memories, magnetic storage devices, or the like.

Computer program code or “code” for carrying out operations according to the present invention may be written in an object oriented programming language such as JAVA®, JavaScript®, Visual Basic®, C, C++ or in various other programming languages or may be written in the form of a spreadsheet such as one which is run in a Microsoft Excels® or Lotus 123 operating environment. Software embodiments of the present invention do not depend on implementation with a particular programming language or spreadsheet. Portions of the code may execute entirely on one or more systems utilized by a server in the network or a mobile device.

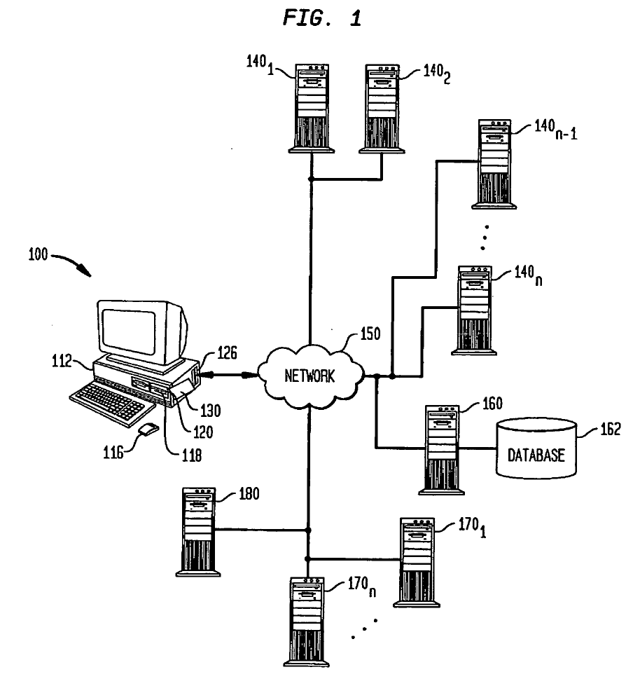

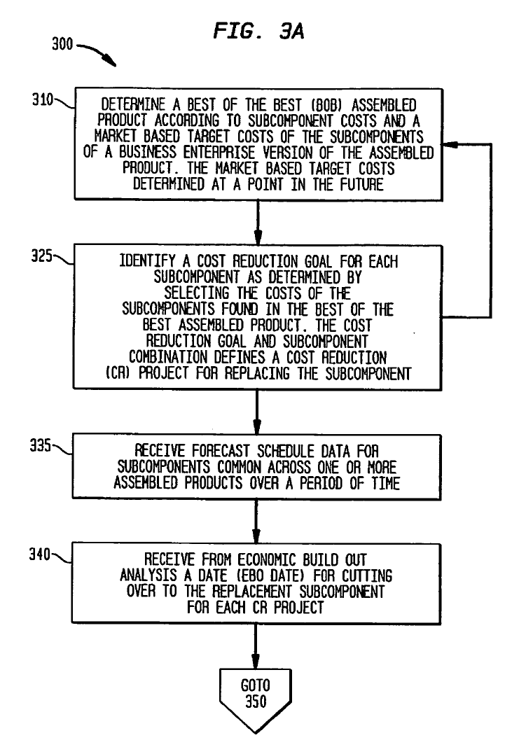

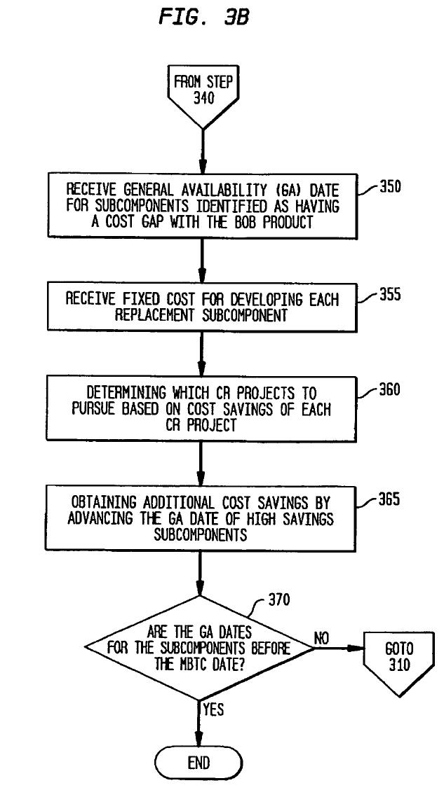

FIG. 1 shows a diagram of a system 100 employing a cost reduction project management system in accordance with the present invention. The illustrated system 100 is shown implemented as a stand-alone personal computer or workstation 112. As described in further detail below, system 100 includes cost reduction project management software 130 in accordance with the present invention which is stored in memory and run by the central processing unit of the personal computer 112. The presently preferred cost reduction project management software 130 is embodied in an Excel spreadsheet. However, the present invention contemplates that the data stored in the Excel spreadsheet may alternatively be stored in a database. In that environment, the cost reduction project management software 130 may be embodied as a program which stores, retrieves, and modifies the data in the database. Cost reduction project management software 130 achieves one or more of the steps defined in FIG. 3.

The computer 112 includes a number of standard input and output devices, including a keyboard 114, mouse 116, CD-ROM drive 118, disk drive 120, and monitor 122. Optionally, the computer 112 includes an Internet or network connection 126 to automatically retrieve over network 150 input data utilized by cost reduction project management software 130 such as inventory data of sub-components from remote suppliers utilizing known systems such as electronic manufacturer services (EMS), supply chain portal, Webplan®, DataMart® implemented on computing systems 140₁ . . . 140ₙ, respectively, general availability dates for subcomponents from design and development system 180, forecast data for assembled product from customer systems 170₁ . . . 170ₙ or a sales system 160 containing a database 162 which tracks won and lost contracts. Alternatively or in combination with automatically retrieving input data over network 150, input data may be manually inputted into cost reduction project management software 130.

It will be appreciated, in light of the present description of the invention, that the present invention may be practiced in any of a number of different computing environments without departing from the scope of the invention. For example, the system 100 may be implemented with portions of the cost reduction project management software 130 executing on one or more workstations connected to each other over network 150 or a portion of the cost reduction project management software 130 may execute on a server while a complementary portion of the cost reduction project management software 130 may execute on a workstation networked to the server. Also, other input and output devices such as laptops, handheld devices, or cell phones, for example, may be used, as desired.

One embodiment of the invention has been designed for use on a stand-alone personal computer, laptop, or workstation on an Intel Pentium or later processor, using as an operating system Windows XP, Windows NT, Linux, or the like.

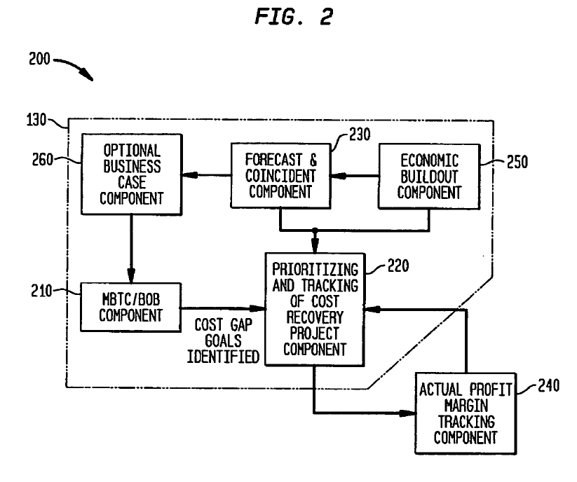

FIG. 2 shows the software components of and interfacing to the cost reduction project management software 130 of FIG. 1 for managing cost reduction projects in accordance with the present invention. Cost reduction project management software 130 includes a market based target cost (MBTC)/best of the best (BOB) component 210, a prioritizing and tracking component 220, an economic buildout component 250, a forecast and coincident component 230, and an optional business case component 260. Cost reduction project management software 130 interfaces with a known actual profit margin tracking component 240. The actual profit margin tracking component 240 receives projected cost savings from the prioritizing and tracking of cost reduction project component 220 and revenue data for sold product.

The economic buildout component 250 utilizes cost data of old and new unique subcomponents and weekly and total forecast or demand for an assembled product to determine at what point in time the old assembled product should cease assembly and the new assembled product should begin assembly. An exemplary embodiment of an economic buildout component 250 is discussed further in commonly owned patent application entitled “System and Methods For Reducing Stranded Inventory” U.S. patent application Ser. No. ______, filed concurrently with this application which is hereby incorporated by reference herein in its entirety.

The forecast and coincident component 230 receives sales forecast data for one or more configurations of an assembled product, decomposes the one or more configurations into subcomponents, and determines a forecast schedule over time for the subcomponents composing the one or more configurations. An exemplary embodiment of the forecast and coincident component 230 is discussed further in commonly owned patent application entitled “System and Methods for Producing a Forecast Schedule of Subcomponents” U.S. patent application Ser. No. ______, filed concurrently with this application which is hereby incorporated by reference herein in its entirety.

The optional business case component 260 compares costs of subcomponents of two or more technologies which address configurations of an assembled product over a period of time. The optional business case component 260 may receive sales forecast data from the forecast and coincident component 230 or from manual input for subcomponents over time and across a variety of configurations of the assembled product. The optional business case component 260 also receives usage data of subcomponents of a technology to address configurations of the assembled product. The optional business case component 260 determines relative cost savings over time between the one or more technologies according to a forecast plan of the assembled product. The optional business case component 260 may automatically select the most cost effective technology for a given forecast plan. The selected technology and corresponding usage data associated with the subcomponents defining the technology may be transferred to the market based target cost (MBTC)/best of the best (BOB) component 210. An exemplary embodiment of the optional business case component 260 is discussed further in commonly owned patent application entitled “System and Methods of Determining a Business Case for Selecting a Least Cost Technology” U.S. patent application Ser. No. ______, filed concurrently with this application which is hereby incorporated by reference herein in its entirety.

The market based target cost (MBTC)/best of the best (BOB) component 210 receives competitive data on competitor's equivalent product costs, price erosion trends and determines two items. First, a best of the best assembled product is determined by selecting the least cost subcomponent from one or more competitor products and the business enterprise's assembled product and aggregating the selected least cost subcomponent to compose the best of the best assembled product. Second, a market based target cost or goal takes into account a constant profit margin to be achieved at a later point in time. The later point in time is the estimated amount of time it would take to develop and integrate the subcomponents composing the BOB product. Comparing the subcomponent costs of the BOB product with the business enterprise's assembled product identifies cost gaps of like subcomponents between the two. Additionally, if the BOB product is greater than the market based target cost, the subcomponent costs of the BOB product are reduced accordingly. An example of how to determine the BOB cost and market based target cost (MBTC) is discussed further in commonly owned patent application entitled “System and Methods of Managing Cost Reduction Projects to Increase Cost Savings of Replacement Subcomponents” U.S. patent application Ser. No. ______, filed concurrently with this application which is hereby incorporated by reference herein in its entirety.

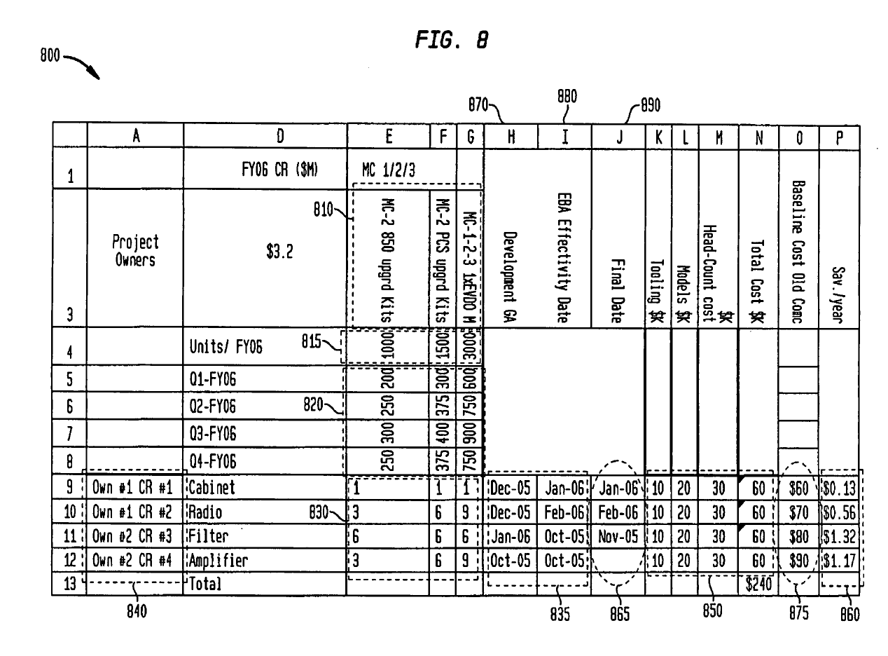

The prioritizing and tracking component 220 receives the fixed cost for developing each new subcomponent, the cutover date from the economic buildout component 250, a general availability date from the design/development team assigned to develop and integrate the new subcomponent into the assembled product and the forecast schedule on a subcomponent basis from the forecast and coincident component 230. The general availability date represents the date at which the new subcomponent will be assembled in the new product for delivery to customers. The prioritizing and tracking component 220 based on cost savings, development cost, and the forecast schedule over which subcomponents will save the most money for the business enterprise over time allows the business enterprise to select which new subcomponents should be pursued. The prioritizing and tracking component 220 also allows subcomponent cost reduction projects to be grouped into sets of cost reduction projects according to resources such as personnel, tools, and the like. Each set of cost reduction projects are assigned to project owners who have authority to assign resources across the set of cost reduction projects. The prioritizing and tracking component 220 further provides means to advance a GA date for one subcomponent and delay a GA date for another subcomponent in order to save additional total costs. An exemplary embodiment of the prioritizing and tracking component 220 is discussed further in connection with the description of FIGS. 8-13.

The actual profit margin tracking component 240 receives as input a cost roadmap specifying the cost of subcomponents as a function of time and the actual sales of assembled product containing the subcomponents. The actual profit margin tracking component 240 calculates the total cost of an assembled product containing replaced subcomponents and the total cost of the assembled product containing new subcomponents to calculate a percent reduction in cost. This percent reduction in cost is compared to the BOB product to determine whether the targets/goals established by the MBTC/BOB component 210 are accomplished.

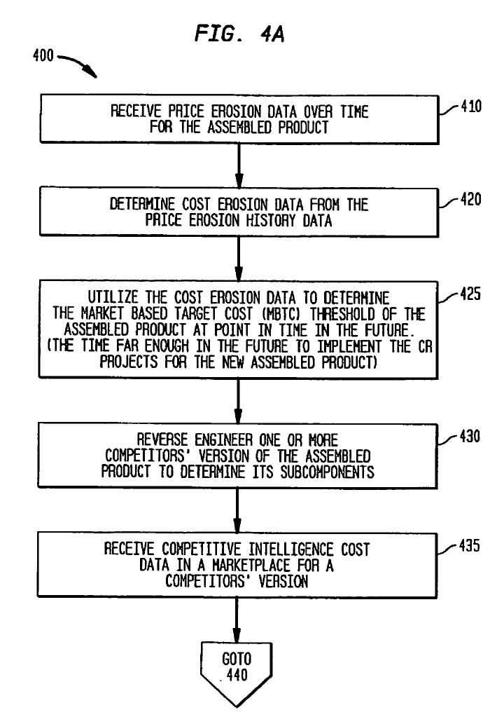

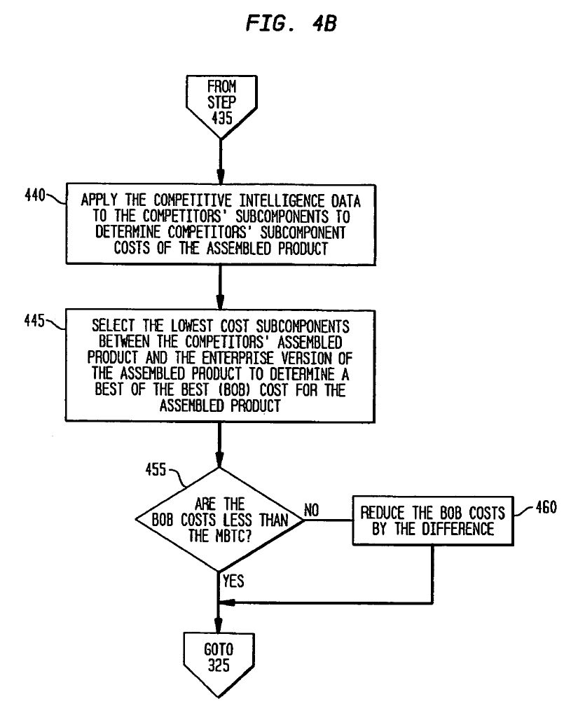

FIG. 3 shows a flow chart of an overall method 300 for managing cost reduction projects in accordance with the present invention. The components of FIG. 2 when executed by system 100 perform one or more of the steps described in the overall method to manage the cost reduction projects. At step 310, a best of the best (BOB) assembled product according to subcomponent costs and market based target costs of the subcomponents of a business enterprise version of the assembled product is determined by, for example, the MBTC/BOB component 210. Further details for determining the BOB assembled product will be discussed in connection with FIG. 4. The market based target costs are determined at a point in the future. The point in the future is a date which initially estimates an amount of time to design, develop and deliver a new assembled product with one or more new subcomponents.

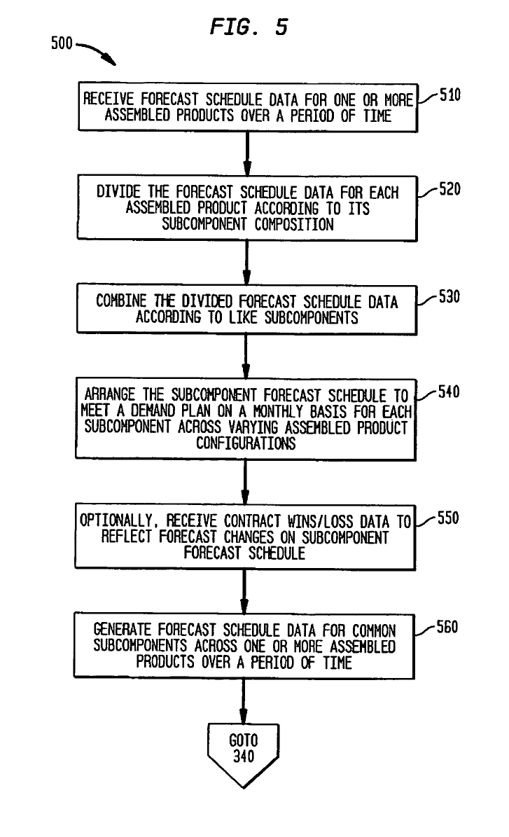

At step 325, a cost reduction goal for each subcomponent is identified by selecting the costs of the subcomponents found in the best of the best assembled product. The cost reduction goal and subcomponent combination defines a cost reduction (CR) project for replacing the subcomponent in a newly assembled product. In some cases, the subcomponent will be replaced with a less expensive version. In other cases, a subcomponent's function may be integrated into a new subcomponent which replaces more than one old subcomponent. At step 335, forecast schedule data for subcomponents common across one or more assembled products over a period of time are received by, for example, the forecast and coincident component 230. Further details for determining forecast schedule data for subcomponents will be discussed in connection with FIG. 5.

At step 340, an economic build out (EBO) analysis date is received. The EBO date indicates the cutover date at which the new product should be assembled in order to either minimize cost and/or stranded inventory. Further details for determining that cutover date are discussed in commonly owned patent application entitled “System and Methods For Reducing Stranded Inventory” U.S. patent application Ser. No. ______.

At step 350, the general availability (GA) date for subcomponents identified as having cost gaps in step 325 is received by, for example, the prioritizing and tracking component 220. These GA dates may be supplied by a development team assigned to developing the new replacement subcomponent. At step 355, fixed costs for developing each replacement subcomponent are received by, for example, the prioritizing and tracking component 220. The fixed costs may be supplied by project managers assigned to tracking the development projects for each replacement subcomponent.

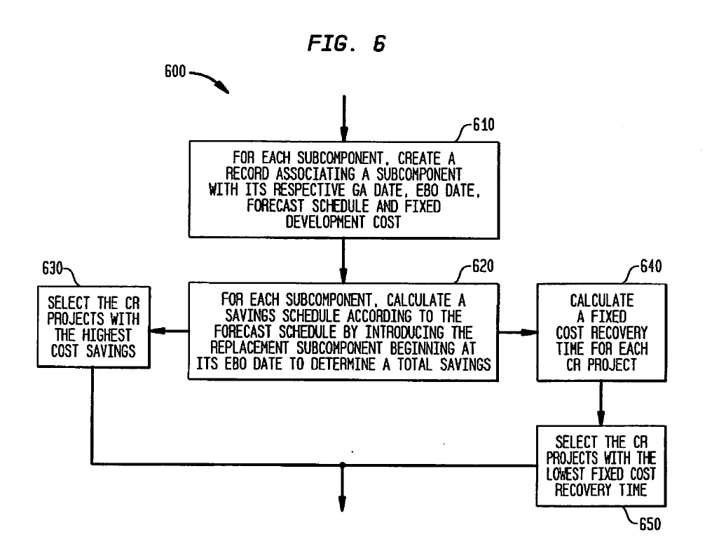

Due to a business enterprises budgetary and/or resource constraints, it may be too costly to pursue each cost reduction project. At step 360, the set of cost reduction projects to pursue, out of those identified as having cost gaps with the BOB, is determined based on the cost savings produced by each cost reduction project. Further details for determining which cost reduction projects to pursue will be discussed in connection with FIG. 6.

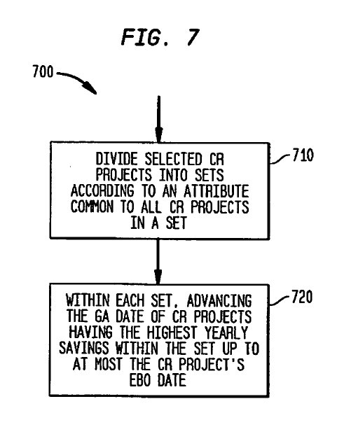

At step 365, additional overall cost savings are obtained by advancing GA dates on subcomponents having high cost savings. Cost savings are advanced when the GA date for a corresponding cost reduction project is made sooner in time. Cost savings are delayed when the GA date for a corresponding cost reduction project is made later in time. Since the GA date is provided by the development team, advancing a GA date would correspond to allocating additional resources to the corresponding cost reduction project and delaying a GA date would typically correspond to removing resources from the corresponding cost reduction project. In order to balance overall resource allocation, when a GA date is advanced on a cost reduction project, a GA date of another cost reduction project is typically delayed. At step 370, the GA dates for all the cost reduction projects are compared against the market based target cost date. Recalling that the MBTC date is an initial estimate, it is compared against the GA dates of the cost reduction projects to see if method 300 should be iterated again. If the GA dates are after the MBTC date, then a new MBTC date should be determined. In that case, method 300 proceeds to step 310. Otherwise, method 300 ends. Further details for extracting additional cost savings determining which cost reduction projects to pursue will be discussed in connection with FIG. 7.

FIG. 4 shows a flow chart of a method 400 for determining a best of the best assembled product according to subcomponent costs and market based target costs in accordance with the present invention. In particular, method 400 further defines step 310 and one or more of the steps of method 400 may be performed by the MBTC/BOB component 210. At step 410, price erosion data over time for an assembled product is received by, for example, the MBTC/BOB component 210. The price erosion data is forward looking in time and reflects a decrease in price due to factors such a shrinking market demand, manufacturing efficiencies, or the like. At step 420, cost erosion data is determined from the price erosion data to sustain profitability. For example, a business enterprise may require a 50% profit margin on an assembled product. In that case, the cost erosion data is found by multiplying the price erosion data by 0.50 at each point in time.

At step 425, the cost erosion data at a particular point in time in the future is a market based target cost (MBTC) which acts as a threshold cost of the assembled product at that particular point in time. The particular point in time is typically set far enough in the future to accomplish the cost reduction projects for a new assembled product. At this point in the overall method 300, the particular point in time is an initial estimated date rather than a firm date.

At step 430, one or more competitors' versions of the assembled product are reverse engineered to determine their subcomponents. At step 435, competitive intelligence cost data for the competitors' subcomponents are received. At step 440, the competitive intelligence cost data is applied to the competitors' subcomponents to determine the costs of the competitors' subcomponents of the assembled product. The lowest cost subcomponents between the competitors' assembled product and the enterprise version of the assembled product are selected to determine a best of the best (BOB) cost for the individual costs for the subcomponents in the assembled product. At step 450, the method compares the total BOB cost with the MBTC determined in step 425. If the total BOB cost is less than or equal to the MBTC, the BOB cost is more than enough to ensure profitability. Method 400 proceeds to step 325 in overall process 300. If the total BOB cost is greater than the MBTC, the BOB cost for the individual costs for the subcomponents in the assembled product, although reduced from the currently assembled product, will not ensure the business enterprise's profitability. In this case, method 400 proceeds to step 455. At step 455, the BOB cost for the individual costs for the subcomponents in the assembled product is reduced by the difference between the MBTC and the total BOB cost determined in step 445. Various techniques may be utilized to reduce the total BOB cost. One technique includes reducing the cost of each subcomponent composing the BOB product by a pro rata amount. Another technique includes reducing the costs of the highest cost subcomponents, subcomponents whose costs are over a predetermined threshold, by a pro rata amount. Method 400 then proceeds to step 325 utilizing the reduced BOB cost. An example on how to determine the BOB cost and market based target cost (MBTC) will be described in connection with the discussion of FIGS. 8-10.

FIG. 5 shows a flow chart of a method 500 for determining forecast schedule data for subcomponents common across one or more assembled products in accordance with the present invention. In particular, method 500 further defines step 335 and one or more of the steps of method 500 may be performed by the prioritizing and tracking component 220. At step 510, forecast schedule data for one or more assembled products over a period of time is received. The one or more assembled products are composed of subcomponents common between the one or more assembled products. In other words, the one or more assembled products may include varying configurations of an assembled product. The forecast data includes the number of assembled products expected to be sold on a monthly basis for a period of time such as over the next 18 months. At step 520, the forecast schedule data for each assembled product is divided according to its subcomponent composition. At step 530, the divided forecast schedule data is combined according to like subcomponents to define a subcomponent forecast schedule. At step 540, the subcomponent forecast schedule is arranged to meet a demand plan on a monthly basis for each subcomponent across varying assembled product configurations. For example, the subcomponent forecast schedule will indicate the number of each subcomponent expected to be utilized on a monthly basis to satisfy customer orders.

At step 550, contract data including won and lost contracts for the sale of assembled products may optionally be received. If this step is invoked, the subcomponent forecast schedule is updated to reflect additional contracts won and lost. Step 550 allows the subcomponent forecast schedule to dynamically track forecast data at a subcomponent level of granularity. At step 560, forecast schedule data for common subcomponents across one or more assembled products over a period of time is generated. The method 500 returns to step 340 of the overall method 300. An exemplary embodiment of the prioritizing and tracking component 220 is discussed further in connection with the discussion of FIGS. 8-13.

FIG. 6 shows a flow chart of a method 600 for determining the set of cost reduction projects to pursue in accordance with the present invention. In particular, method 600 further defines step 360 and one or more of the steps of method 600 may be performed by the prioritizing and tracking component 220. At step 610, a record is created for each subcomponent associating a subcomponent with its respective proposed GA data, EBO date, subcomponent forecast schedule, and fixed development cost. At step 620, a savings schedule for each subcomponent is created on a monthly basis according to the subcomponent forecast schedule found in FIG. 5. The savings schedule will begin accumulating savings on the date the replacement subcomponent goes into live production, the subcomponent's proposed GA date.

Two alternative techniques are utilized to select the set of cost reduction projects according to a business enterprise's budgetary constraints. The first technique is defined by step 630. At step 630, the cost reduction projects with the highest total cost savings are selected. The number of cost reduction projects is determined by applying the budgetary constraints to the fixed costs of the highest total cost savings projects until the budgetary constraints are exhausted. The budgetary constraints are consumed by subtracting out the fixed development costs from the highest total cost savings projects until the budgetary constraints are exhausted.

The second technique for selecting the set of cost reduction projects is defined by steps 640 and 650. At step 640, for each subcomponent identified to have a cost gap with the BOB cost, a fixed cost recovery time is calculated. The fixed cost recovery time indicates how long it takes to recover the fixed costs for developing a new subcomponent by savings caused by use of the new subcomponent in the assembled product. The fixed cost recovery time is determined by adding up the monthly cost savings found in step 620 until the sum of the monthly cost savings first equal or exceed the fixed costs for the corresponding new subcomponent. At step 650, the cost reduction projects with the lowest fixed cost recovery times are selected to be pursued. It should be recognized that different multiples of the fixed cost recovery time, such as two times, four times, ten times the fixed costs, and the like, may be utilized by the present invention in order to prioritize the order in which to pursue cost reduction projects.

FIG. 7 shows a flow chart of a method 700 for extracting additional overall cost savings by advancing the GA date of high savings cost reduction projects in accordance with the present invention. In particular, method 700 further defines step 365 and one or more of the steps of method 700 may be performed by the prioritizing and tracking component 220. At step 710, the selected cost reduction (CR) projects found in step 360 are divided into sets where there is a common attribute shared by each of the cost reduction projects. For example, the cost reduction projects may be divided based on design/development personnel resources assigned to the respective cost reduction projects, locations of development resources, suppliers of the corresponding subcomponent, and the like. Preferably, all the cost reduction projects within a set share the same resources for developing their respective new subcomponent. At step 720, within each set, the GA dates of the cost reduction projects having the higher yearly cost savings are advanced earlier in time with advancement limited to their respective EBO date. In order to effectuate an advancement of a GA date, additional resources have to typically be assigned to the respective cost reduction project. As a result, advancing the cost reduction projects having the highest yearly cost savings may cause one or more cost reduction projects in the same set to have their GA dates delayed. Conversely, delaying a cost reduction project having a lower yearly cost savings, one or more cost reduction projects in the same set having high yearly cost savings may be advanced depending on the relative fixed cost of the delayed cost reduction project.

Each set of CR projects may be assigned to a project owner where the project owner is responsible for analyzing the cost savings of the set of CR projects, advancing the GA dates of higher cost saving CR projects, and, potentially, delaying the GA dates of lower cost savings CR projects. Alternatively, the prioritizing and tracking component 220 may include a threshold automatically categorizing those projects whose cost savings exceed the threshold as higher cost saving CR projects and categorizing those projects whose cost savings do not exceed the threshold as lower cost saving CR. In this environment, the GA dates of the higher cost saving CR projects may be advanced automatically, and the GA dates of the lower cost savings CR projects may be delayed automatically. An exemplary embodiment of how additional cost savings are achieved by advancing the GA date and the related effects of such advancement are discussed further below in connection with the discussion of FIG. 8.

FIGS. 8-13 illustrate portions of the prioritizing and tracking component of FIG. 2 with a spreadsheet utilized to input, output and display relevant data in an advantageous manner. FIG. 8 shows an exemplary spreadsheet 800 utilized in implementing a first portion of the prioritizing and tracking component of FIG. 2 in accordance with the present invention. Spreadsheet 800 includes input areas 810, 815, 820, 830, 835, 840, 850, and 875. Spreadsheet 800 also includes output areas 860 and 865. Input area 810 reflects various configurations or product mixes presently available or to be designed for an assembled product. Columns E, F, and G in input area 810 contain labels indicating three different configurations of the assembled product. Referring to input area 830 in column E, the assembled product contains 1 cabinet, 3 radios, 6 filters, and 3 amplifiers. In column F, on the other hand, the assembled product contains 1 cabinet, 6 radios, 6 filters, and 6 amplifiers. Each column in input area 830 is referred to as the usage factor for a particular configuration. Input area 815 contains the total year demand or forecast data for the three configurations of the assembled product. The data in input area 815 is determined by contracts for sales of assembled product. As the sales of any of the configurations go up, the total year demand for the corresponding configuration goes up accordingly. Consequently, when contracts are won or lost the data in input area 815 is modified manually or programmatically to reflect those sales conditions. As an example of programmatic updating, as sales data is entered in a sales database, for example, upon entry of a contract, a tracking program tracks the updated sales data and automatically reports it to the prioritizing and tracking component 220.

When modified programmatically, the prioritizing and tracking component 220 allows for continuous input of supplier contracted pricing and direct purchase component costs. The prioritizing and tracking component 220 continuously multiplies the usage factors in input area 830 by updated forecast data for each assembled product configuration.

Input area 820 distributes the yearly demand from input area 815 across the four quarters in an upcoming year according to the delivery time on won contracts. Input area 840 shows two project owners. Owner #1 is assigned the cabinet and the radio cost reduction projects. Owner #2 is assigned the filter and amplifier cost reduction projects. Although not illustrated in FIG. 8, the same resources such as design and development personnel assigned to replace the cabinet subcomponent are the same resources assigned to replacing the radio subcomponent. Similarly, the same resources assigned to replace the filter subcomponent are the same resources assigned to replacing the amplifier subcomponent.

Input area 850 indicates the fixed costs for a corresponding cost reduction project. Input area 875 indicates the unit cost of the old subcomponent. Input area 835 contains the GA dates and economic buildout dates associated with each cost reduction project. The GA dates shown in column 870 and the economic buildout dates in column 880 are retrieved from the economic and buildout component 250. As a reminder, the GA dates from the economic and buildout component 250 are estimated dates provided by the development team responsible for developing the new subcomponent and are based on a particular set of resources.

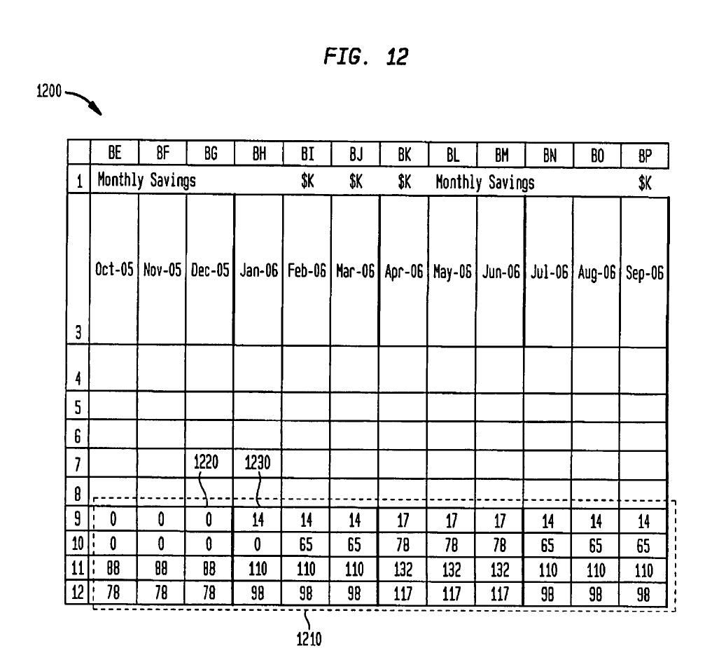

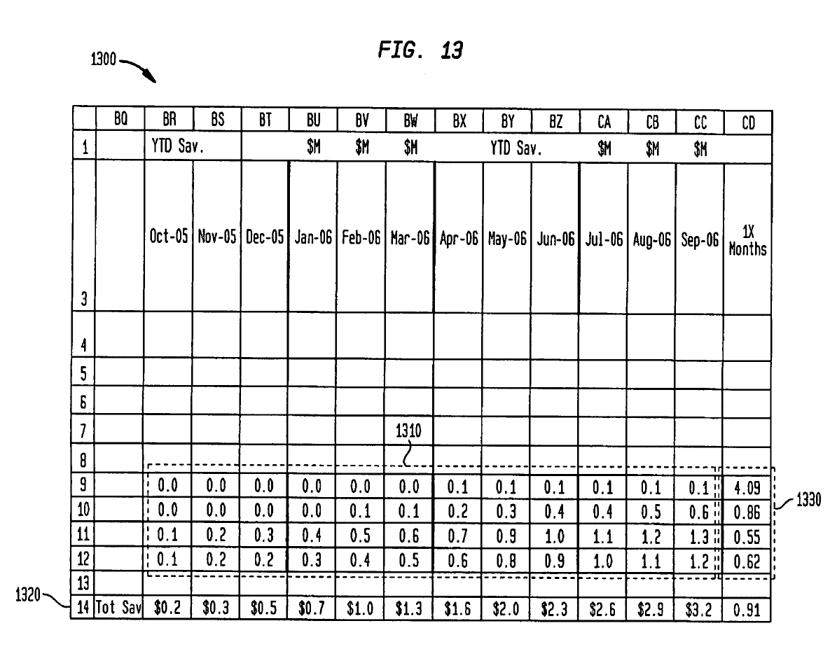

Output area 850 in column 890 indicates the final GA dates as determined by advancing or delaying the GA dates of column 870 as described in step 720 of FIG. 7. The contents of output area 860 indicate the total cost savings by introducing the new subcomponents according to their corresponding final date. The contents of output area 860 change when the GA dates in column 870 are advanced earlier in time or delayed later in time. In this way, a project owner such as Owner #1, can adjust the final dates of the corresponding projects assigned to him or her to see how the cost savings in output area 860 change, allowing each project owner to find and evaluate the pros and cons of additional cost savings. The contents of output area 860 are calculated on the total cost savings calculation as shown in FIG. 13. The total cost savings may be ordered by a project owner or automatically sorted to prioritize the cost reduction projects to be pursued. A specific number of cost reduction projects to pursue is determined by the budget of the business enterprise allocated for such a task. It should be noted that the cost savings in FIGS. 12 and 13 are shown before the GA dates were advanced or delayed.

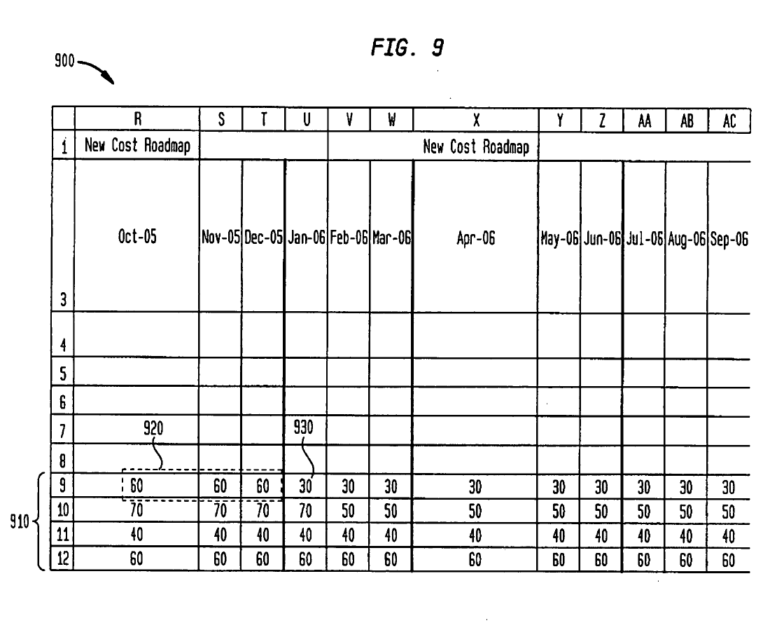

When any of the input areas 810, 815, 820, 830, 835, 840, 850, and 875 are modified, either manually or programmatically by interfacing with other software components and sources of data, the output areas of spreadsheet 800 and the spreadsheets discussed in FIGS. 9-13 are automatically updated to reflect the corresponding modification.

FIG. 9 shows an exemplary cost roadmap spreadsheet 900 utilized in implementing a second portion of the prioritizing and tracking component of FIG. 2 in accordance with the present invention. The cost roadmap 900 shows the unit costs for each subcomponent composing an assembled product over time. In particular, the timeframe chosen to list the per unit costs is typically determined by the latest final date of a cost reduction project. For example, Row 11 shows the cost of the amplifier subcomponent as 60K remaining constant for each month from October-05 to September-06 indicating that either the amplifier's final date for delivery into an assembled product is past September-06 or the cost reduction project for the amplifier is postponed altogether. Such a postponement is possible in order to move a previously assigned resource from the amplifier cost reduction project to another cost reduction project. Rows 910 correspond to the cabinet, radio, filter, amplifier subcomponents shown in rows 9-12 of FIG. 8.

Display area 920 shows the unit costs for the cabinet subcomponent being $60K through December-05. At area 930, the unit costs for the cabinet subcomponent is $30K beginning in January-06 indicating the month in which the new cabinet subcomponent is being assembled with the assemble product.

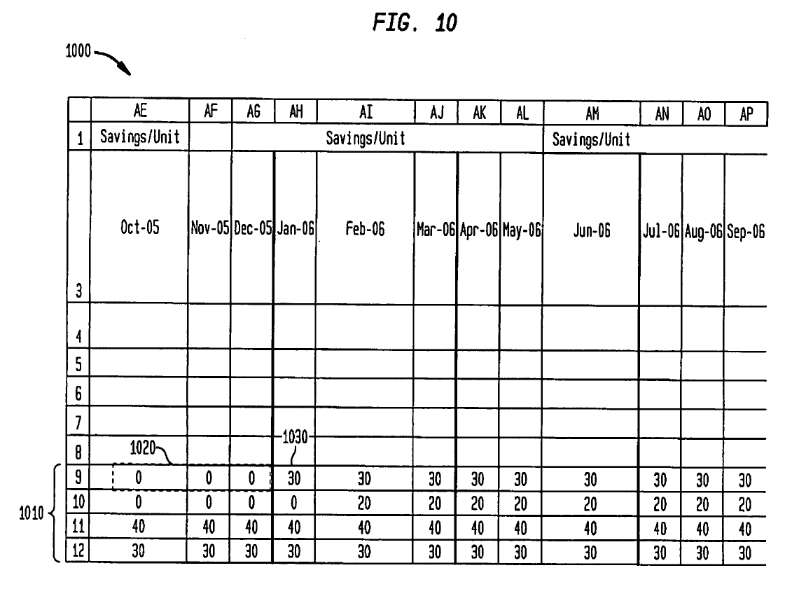

FIG. 10 shows an exemplary savings per subcomponent roadmap spreadsheet 1000 utilized in implementing a third portion of the prioritizing and tracking component of FIG. 2 in accordance with the present invention. The cost savings per subcomponent roadmap 1000 shows the unit savings for each subcomponent composing an assembled product over time. Rows 1010 correspond to the cabinet, radio, filter, amplifier subcomponents shown in rows 9-12 of FIG. 8.

Display area 1020 shows the unit savings for the cabinet subcomponent being $0 through December-05 because the old cabinet subcomponent is being used in the assembled product. At area 1030, the unit savings for the cabinet subcomponent is $30K beginning in January-06 indicating the month in which the new cabinet subcomponent is being assembled in the new product to be assembled.

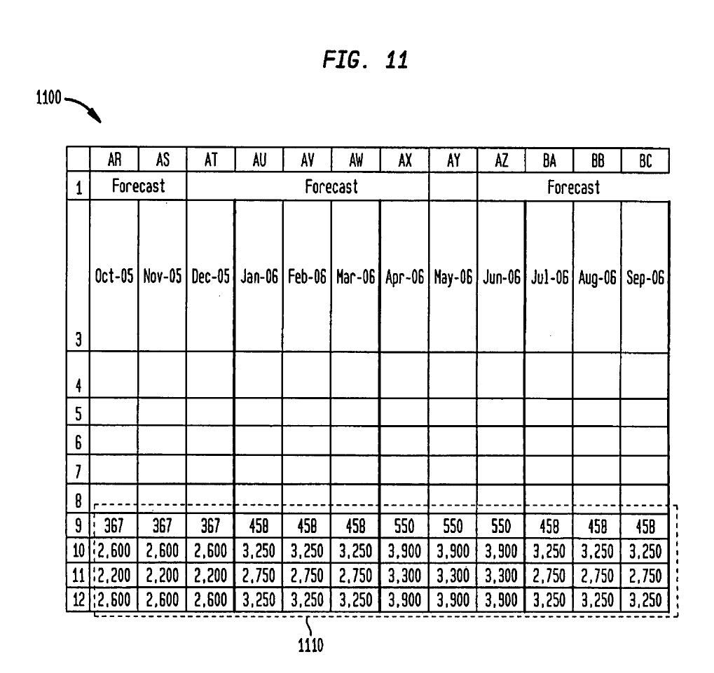

FIG. 11 shows an exemplary forecast roadmap spreadsheet 1100 to display forecast data on a subcomponent basis in accordance with the present invention. The forecast roadmap 1100 indicates the forecast for each subcomponent such as the cabinet, radio, filter, and amplifier subcomponents over time. The total forecasts for all assembled products utilizing cabinet, radio, filter, and amplifier subcomponents such as input area 815 are accumulated and distributed according to a per assembled usage factor as shown in input area 830. The particular distribution for each subcomponent is divided per quarter based on the quarterly forecast of the assembled products shown in input area 820. In other words, output display area 1110 distributes the total annual forecast for each individual subcomponent on a subcomponent basis across each quarter to meet the assembled product forecast in input area 820. Furthermore, within each quarter, output display area 850 distributes the quarterly forecast for each subcomponent on a subcomponent basis across each month in the respective quarter.

For example, the total yearly demand for assembled products containing common subcomponents such as the cabinet, radio, filter, and amplifier subcomponents is 5500 units as shown by summing the total yearly units in input area 815. In the first quarter of 2006 which in the example shown is October-05 to December-05, 1100 units are expected to be sold. Since only one cabinet per assembled configuration is added to the three assembled configurations shown in input area 810, 1100 cabinet units will be needed over the first quarter of 2006. Consequently, the 1100 cabinet units are divided equally, 367 cabinet units per monthly period, across the October-05 through December-05 quarter.

FIG. 12 shows a monthly savings spreadsheet 1200 in accordance with the present invention. Output area 1210 calculates the monthly savings on a subcomponent basis over time by multiplying the monthly forecast roadmap of FIG. 11 with the monthly per unit savings of FIG. 10.

FIG. 13 shows year-to-date savings spreadsheet 1300 in accordance with the present invention. Output area 1310 calculates the year-to-data savings by accumulating the monthly savings shown in FIG. 12. Row 1320 shows the total savings for all the subcomponents on a monthly basis. Output area 1330 displays a cost reduction time, the number of months it takes for an individual cost reduction project to achieve over time a reduction in costs equal to the fixed costs for undertaking the individual cost reduction project. For example, the cabinet shown in row 9 takes 4.09 months for the cost savings to accumulate by introducing the new cabinet before the cost savings substantially equals the fixed costs shown in input area 875. In input area 875, the fixed cost for introducing a new cabinet is $60K. Since the new cabinet was planned to be introduced January-06, the fixed costs would be recovered in cost savings by introducing the new cabinet in the early part of May-06.

The cost reduction time is a measurement, regardless of when cost savings begin to accumulate, which identifies the cost reduction projects that have the highest return on investment as measured by cost savings. This constant measurement allows project managers or other users of the prioritizing and tracking component 220 to assess which cost reduction projects have the best return regardless of the different scenarios for project performance which will be readily considered by varying the final date of input area 865. With the cost reduction time measurement, a user of the prioritizing and tracking tool can meet a budgetary constraint and assess whether to cancel a cost reduction project having a high cost reduction time measurement. It should be noted that other multiples of a cost reduction time may be utilized in assessing a cost reduction project's return on investment such as two times costs, three times cost, ten times costs, or the like.

Another embodiment of FIGS. 8-13 includes creating records in a memory or a database in system 100 based on the inputs discussed in FIG. 8. Additionally, by assigning cost reduction projects by a common attribute such as personnel resources assigned to a subcomponent, the cost reduction projects can be grouped into sets automatically based on the common attribute. Other examples of the common attribute include geographic locations of design/development teams, suppliers of subcomponents, countries of origin for suppliers of subcomponents, or the like. Furthermore, in this embodiment, advancing and delaying the final date within the bounds created by the development GA date and the economic buildout date can also be performed automatically by software 130. Software 130, in this embodiment, would also automatically select final dates within the boundaries defined by the proposed development GA date and the economic build out date for each cost reduction project on a set basis to maximize additional cost savings as discussed above in connection with the discussion of FIG. 8.

While the present invention has been disclosed mainly in the context of sub-components and assembled products, it will be recognized that the present teachings are applicable to a wide variety of manufactured products such as cell phones, internet protocol (IP) routers, wireless access points, or the like, which contain components manufactured or assembled by multiple suppliers.

We claim:

1. A computer implemented method for prioritizing cost reduction projects for replacing subcomponents utilized in an assembled product with new subcomponents, the computer implemented method comprising:
receiving forecasting data for subcomponents utilized in the assembled product;
determining from the forecasting data a cost savings schedule for said subcomponents of costs saved by introducing said new subcomponents;
calculating the total costs savings for each cost reduction project; and
sorting the cost reduction projects according to their respective total cost savings to determine which cost reduction projects should be pursued.

2. The computer implemented method of claim 1 further comprising:
displaying an output of one or more cost reduction projects to be selected.

3. The computer implemented method of claim 2 wherein the selected one or more cost reduction projects have high total cost savings, the number of cost reduction projects selected being limited by applying a predetermined budget.

4. The computer implemented method of claim 2 wherein the selected one or more cost reduction projects have low fixed cost recovery time, the number of cost reduction projects selected with low fixed cost recovery time being limited by applying a predetermined budget.

5. The computer implemented method of claim 1 wherein cost savings from the cost savings schedule begin at each subcomponent's proposed general availability (GA) date.

6. The computer implemented method of claim 5 further comprising:
advancing a subcomponent's proposed GA date to increase total cost savings.

7. The computer implemented method of claim 5 further comprising:
delaying a subcomponent's proposed GA data to free resources allocated thereto.

8. The computer implemented method of claim 7 further comprising:
assigning the freed resources to another cost reduction project.

9. A computer readable medium whose contents cause a computer to prioritize cost reduction projects for replacing subcomponents utilized in an assembled product with new subcomponents, by performing the steps of:
receiving forecasting data for subcomponents utilized in the assembled product;
determining from the forecasting data a cost savings schedule for said subcomponents of costs saved by introducing said new subcomponents;
calculating the total costs savings for each cost reduction project; and
sorting the cost reduction projects according their respective total cost savings to determine which cost reduction projects should be pursued.

10. The computer readable medium of claim 9 further comprising:
displaying one or more cost reduction projects to be selected.

11. The computer readable medium of claim 10 wherein the selected one or more cost reduction projects have high total cost savings, the number of cost reduction projects selected being limited by applying a predetermined budget.

12. The computer readable medium of claim 10 wherein the selected one or more cost reduction projects have low fixed cost recovery time, the number of cost reduction projects selected with low fixed cost recovery time being limited by applying a predetermined budget.

13. The computer readable medium of claim 9 wherein cost savings from the cost savings schedule begin at each subcomponent's proposed general availability (GA) date.

14. The computer readable medium of claim 13 further comprising:
advancing a subcomponent's proposed GA date to increase total cost savings.

15. The computer readable medium of claim 13 further comprising:
delaying a subcomponent's proposed GA data to free resources allocated thereto.

16. The computer readable medium of claim 15 further comprising:
assigning the freed resources to another cost reduction project.

17. A system prioritizing cost reduction projects for replacing subcomponents utilized in an assembled product with new subcomponents, the system comprising:
means for receiving forecasting data for subcomponents utilized in the assembled product;
means for determining from the forecasting data a cost savings schedule for said subcomponents of costs saved by introducing said new subcomponents;
means for calculating the total costs savings for each cost reduction project; and
means for sorting the cost reduction projects according to their respective total cost savings to determine which cost reduction projects should be pursued.

18. The system of claim 17 further comprising:
means for displaying an output of one or more cost reduction projects to be selected.

19. The system of claim 18 wherein the selected one or more cost reduction projects have high total cost savings, the number of cost reduction projects selected being limited by applying a predetermined budget.

20. The system of claim 18 wherein the selected one or more cost reduction projects have low fixed cost recovery time, the number of cost reduction projects selected with low fixed cost recovery time being limited by applying a predetermined budget.
